(19) United States
(12) Patent Application Publication
(10) Pub. No.: US 2023/0111642 A1
(43) Pub. Date: Apr. 13, 2023

(54) ELECTRODE SHEET AND ELECTRODE SHEET ASSEMBLY

(71) Applicant: Xiamen Hithium Energy Storage Technology Co., Ltd., Xiamen (CN)

(72) Inventors: Congmiao Wu, Xiamen (CN); Zhen Ye, Xiamen (CN); Cheng Huang, Xiamen (CN); Dengke Feng, Xiamen (CN)

(73) Assignee: Xiamen Hithium Energy Storage Technology Co., Ltd., Xiamen (CN)

(21) Appl. No.: 17/949,524

(22) Filed: Sep. 21, 2022

(30) Foreign Application Priority Data
Oct. 12, 2021 (CN) 202111188969.2
Oct. 12, 2021 (CN) 202122458063.X

(51) Int. Cl. H01M 4/66; H01M 4/58; H01M 4/587; H01M 4/36

(52) U.S. Cl. CPC H01M 4/667; H01M 4/5825; H01M 4/587; H01M 4/366; H01M 2004/021

(57) ABSTRACT

An electrode sheet and an electrode sheet assembly are provided. The electrode sheet includes a current collector, a first active material layer, and a second active material layer. The current collector has a first surface and a second surface opposite to the first surface. The first active material layer covers at least a part of the first surface. The second active material layer covers at least a part of the second surface. The first active material layer is different from the second active material layer. The first active material layer and the second active material layer have different particle size distributions.

### CROSS-REFERENCE TO RELATED APPLICATIONS

This application claims priority under 35 U.S.C. § 119(a) to Chinese Patent Application No. 202122458063.X, filed Oct. 12, 2021, and Chinese Patent Application No. 202111188969.2, filed Oct. 12, 2021, the entire disclosures of which are incorporated herein by reference.

### TECHNICAL FIELD

This disclosure relates to the field of batteries, and in particular to an electrode sheet and an electrode sheet assembly.

### BACKGROUND

An electrode sheet mainly includes a current collector and an active material. In detail, the active material is coated on two sides of the current collector. The electrode sheet is a core component of a battery and will seriously affect an electrical performance of the battery. In the present disclosure, the electrode sheet is provided to improve the electrical performance of the battery.

### SUMMARY

An electrode sheet is provided in the present disclosure. The electrode sheet includes a current collector, a first active material layer, and a second active material layer. The current collector has a first surface and a second surface opposite to the first surface. The first active material layer covers at least a part of the first surface. The second active material layer covers at least a part of the second surface.

An electrode sheet assembly is further provided in the present disclosure. The electrode sheet assembly includes a separator, and two electrode sheets which are located at two sides of the separator and with opposite polarities. At least one of the two electrode sheets is an electrode sheet. The electrode sheet includes a current collector, a first active material layer, and a second active material layer. The current collector has a first surface and a second surface opposite to the first surface. The first active material layer covers at least a part of the first surface. The second active material layer covers at least a part of the second surface.

### BRIEF DESCRIPTION OF THE DRAWINGS

In order to clearly explain technical solutions of implementations of the present disclosure, accompanying drawings used in the implementations are briefly described below. It should be understood that the accompanying drawings as described below merely illustrate some implementations of the present disclosure, and should not be construed as limiting the scope. For those of ordinary skill in the art, other accompanying drawings can also be obtained according to these accompanying drawings without creative efforts.

FIG. 1 is a schematic cross-sectional structural diagram of an electrode sheet provided in an implementation of the present disclosure.

FIG. 2 is a schematic cross-sectional structural diagram of an electrode sheet provided in another implementation of the present disclosure.

FIG. 3 is a schematic cross-sectional structural diagram of an electrode sheet assembly provided in implementations of the present disclosure.

Signs: 100, 200—electrode sheet; 101, 201—current collector; 102—first surface; 103—second surface; 110—first active material layer; 120—second active material layer; 203—support layer; 202—metal layer; 300—electrode sheet assembly; 301—first electrode sheet; 302—second electrode sheet; 303—third electrode sheet; 304—fourth electrode sheet; 305—separator.

### DETAILED DESCRIPTION

In order to make a purpose, a technical solution, and an advantage of implementations of the present disclosure clearer, the technical solution of the implementations of the present disclosure will be described clearly and completely in conjunction with accompanying drawings in the implementations of the present disclosure. Obviously, described implementations are part of the implementations of the present disclosure, not all of the implementations. Generally, the assemblies of implementations of the present disclosure, which are described and illustrated in the accompanying drawings herein, may be arranged and designed in a variety of different configurations.

Therefore, the detailed description of the implementations of the present disclosure provided in the accompanying drawings is not intended to limit the claimed scope of the present disclosure, but illustrates only the selected implementations of the present disclosure. All the other implementations, obtained by those of ordinary skill in the art in light of the implementations of the present disclosure without inventive efforts, will all fall within the claimed scope of the present disclosure.

It should be noted that similar signs and letters indicate similar items in the following accompanying drawings, and therefore, once an item is defined in an accompanying drawing, it is not necessary to further define or explain it in the subsequent accompanying drawings.

In the description of the implementations of the present disclosure, it should be understood that orientation or positional relations indicated by terms such as “center”, “up”, “down”, “left”, “right”, “vertical”, “horizontal”, “inside”, and “outside” are orientation or positional relations based on the accompanying drawings, or orientation or positional relations in which the application product is placed conventionally in use, or orientation or positional relations commonly understood by those of ordinary skill in the art, only for facilitating description of the present disclosure and simplifying the description, rather than indicating or implying that the referred devices or elements must be in a particular orientation or constructed or operated in the particular orientation, and therefore they should not be construed as position limiting the present disclosure.

In addition, terms such as “first”, “second”, and “third” are used only for distinguishing the description, and should not be construed as indicating or implying relativity importance.

In the description of the present disclosure, it should be indicated that unless otherwise expressly specified or defined, terms such as “provide”, “mount”, “couple”, and “connect” should be understood broadly, and for example, a fixed connection, or a detachable connection, or an integrated connection; may be a mechanical connection or an electric connection; and may be a direct connection, or an indirect connection via an intermediate medium, or may be an internal communication between two elements. The specific meanings of the above-mentioned terms in the present disclosure could be understood by those of ordinary skill in the art according to specific situations.

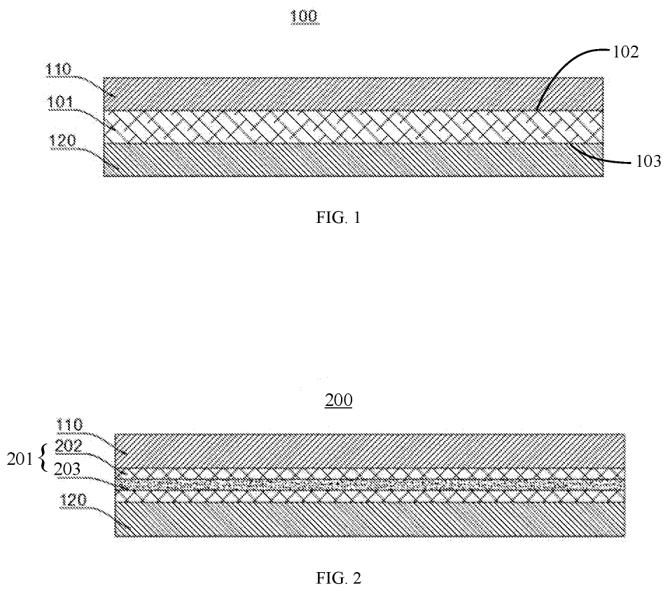

FIG. 1 is a schematic cross-sectional structural diagram of an electrode sheet 100 provided in an implementation of the present disclosure. As illustrated in FIG. 1, the electrode sheet 100 is provided in the implementations of the present disclosure. The electrode sheet 100 includes a first active material layer 100, a second active material layer 120, and a current collector 101. The current collector 101 has two opposite surfaces which are a first surface 102 and a second surface 103. The first active material layer 110 covers at least a part of the first surface 102. The second active material layer 120 covers at least a part of the second surface 103.

The first active material layer 110 is mainly made of an active material, a conductive agent, and an adhesive agent.

The second active material layer 120 is mainly made of the active material, the conductive agent, and the adhesive agent.

For example, the adhesive agent can be selected from one or more of styrene-butadiene rubber, polyvinyl alcohol, and polypropylene glycol. For example, the conductive agent can be selected from one or more of super-p, conductive carbon black, or conductive graphite.

The active material can be selected according to a polarity of the electrode sheet 100. In implementations where the electrode sheet 100 is a positive electrode sheet, the active material may be, for example, one or more of lithium iron phosphate, lithium manganate, lithium cobalt oxide, lithium manganese oxide, lithium nickel oxide, lithium nickel cobalt manganese oxide, lithium nickel manganese oxide, or lithium nickel cobalt aluminum oxide.

In implementations where the electrode sheet 100 is a negative electrode sheet, the active material may be, for example, one or more of artificial graphite, natural graphite, soft carbon, hard carbon, or mesocarbon microbeads.

In the implementations, a particle size distribution of the first active material layer 110 is different from a particle size distribution of the second active material layer 120.

In other words, in a process of preparation of the first active material layer 110 and the second material layer, a slurry containing an active material is coated on the current collector 101. A slurry of the first active material layer 110 is different from a slurry of the second active material layer 120, e.g., active materials have different physical or chemical performances, or the slurry of the first active material layer 110 is identical with the slurry of the second active material layer 120, but a coating process of the first active material layer 110 is different from a coating process of the second active material layer 120, so as to obtain different first active material layer 110 and second active material layer 120.

In the present disclosure, the following is an exemplary description of a difference between the particle size distribution of the first active material layer 110 and the particle size distribution of the second active material layer 120.

The first active material layer 110 and the second active material layer 120 have different particle sizes.

In implementations where the electrode sheet is the positive electrode sheet and the first active material layer 110 and the second active material layer 120 have identical active materials, active material particles are different in a particle size D10, a particle size D50, and a particle size D90. D10 represents that 10% of particles in the active material particles are smaller than this particle size; D50 represents that 50% of particles in the active material particles are smaller than this particle size; and D90 represents that 90% of particles in the active material particles are smaller than this particle size. In the implementations, a difference between the particle size D10 of active material particles of the first active material layer 110 and the particle size D10 of active material particles of the second active material layer 120 is 0.05 μm˜0.3 μm (e.g., 0.05 μm, 0.08 μm, 0.1 μm, 0.15 μm, 0.19 μm, 0.2 μm, 0.23 μm, 0.25 μm, 0.3 μm, etc.); a difference between the particle size D50 of active material particles of the first active material layer 110 and the particle size D50 of active material particles of the second active material layer 120 is 1 μm˜4 μm (e.g., 1 μm, 1.2 μm, 1.5 μm, 1.7 μm, 2.1 μm, 2.4 μm, 2.9 μm, 3.4 μm, 4 μm, etc.); and a difference between the particle size D90 of active material particles of the first active material layer 110 and the particle size D90 of active material particles of the second active material layer 120 is 3 μm˜5 μm (e.g., 3 μm, 3.3 μm, 3.6 μm, 4 μm, 4.2 μm, 4.6 μm, 5 μm, etc.).

A relatively large particle size of the active material will lead to a relatively long ion migration path and a poor rate capability. A relatively small particle size of the active material will lead to a great rate capability, but difficult dispersion. A combination of a large particle size and a small particle size is beneficial to improve a cycle life.

In the implementations, the first active material layer 110 and the second active material layer 120 have the identical active materials, and active material particles of two layers meet the above conditions, such that an identical battery has good charge-and-discharge characteristics at different rates. In a case of high charge-and-discharge rates, an active material layer at one side with a small particle size takes more current, which avoids a safety problem caused by serious polarization and even a safety problem caused by a phenomenon of lithium precipitation, due to large current. At the same time, for one side with a large particle size, a difficulty of powder dispersion during stirring is reduced and a processing performance is improved.

In implementations where the electrode sheeting 100 is the positive electrode sheet and the first active material layer 110 and the second active material layer 120 have different active materials, active material particles are different in particle sizes of D10, D50, and D90. A difference between particle sizes of D10 of active material particles of two layers is 1 μm˜3 μm (e.g., 1 μm, 1.2 μm, 1.6 μm, 1.8 μm, 2.1 μm, 2.3 μm, 2.7 μm, 3 μm, etc.); a difference between particle seizes of D50 of active material particles of the two layers is 2 μm˜5 μm (e.g., 2 μm, 2.3 μm, 2.6 μm, 3 μm, 3.2 μm, 3.6 μm, 4 μm, 5 μm, etc.); and a difference between particle sizes of D90 of active material particles of the two layers is 3 μm˜25 μm (e.g., 3 μm, 3.5 μm, 4 μm, 4.6 μm, 5.4 μm, 6.7 μm, 7.6 μm, 8.9 μm, 10 μm, 15 μm, 17 μm, 20 μm, 25 μm, etc.).

The first active material layer 110 and the second active material layer 120 have different active materials, and active material particles of two layers meet the above conditions, such that an identical battery has good charge-and-discharge characteristics at different rates, and inherits an energy density, high/low temperature characteristics, rate discharge characteristics, etc., of positive/negative materials. Since different operating conditions are adapted, abnormal situations during charging and discharging can be reduced, and a battery life can be prolonged to a certain extent.

In implementations where the electrode sheeting is a negative electrode sheet, the first active material layer 110 and the second active material layer 120 have identical active materials. A difference between the particle size D10 of active material particles of the first active material layer 110 and the particle size D10 of active material particles of the second active material layer 120 is 0.1 μm˜4 μm (e.g., 0.1 μm, 0.5 μm, 1 μm, 3 μm, 3.2 μm, 3.6 μm, 4 μm, etc.); a difference between the particle size D50 of active material particles of the first active material layer 110 and the particle size D50 of active material particles of the second active material layer 120 is 0.1 μm˜8 μm (e.g., 0.1 μm, 0.5 μm, 1 μm, 2 μm, 4 μm, 5 μm, 7 μm, 7.6 μm, 8 μm, etc.); and a difference between the particle size D90 of active material particles of the first active material layer 110 and the particle size D90 of active material particles of the second active material layer 120 is 0.1 μm˜10 μm (e.g., 0.3 μm, 2 μm, 3 μm, 4.6 μm, 5.5 μm, 6.9 μm, 7.6 μm, 8.9 μm, 10 μm, etc.).

In implementations where the electrode sheeting is a negative electrode sheet, the first active material layer 110 and the second active material layer 120 have different active materials. A difference between the particle size D10 of active material particles of the first active material layer 110 and the particle size D10 of active material particles of the second active material layer 120 is 0.1 μm˜4 μm (e.g., 0.1 μm, 0.4 μm, 1 μm, 2.2 μm, 3.4 μm, 3.7 μm, 4 μm, etc.); a difference between the particle size D50 of active material particles of the first active material layer 110 and the particle size D50 of active material particles of the second active material layer 120 is 0.1 μm˜10 μm (e.g., 0.3 μm, 2 μm, 3 μm, 4.6 μm, 5.5 μm, 6.9 μm, 7.6 μm, 8.9 μm, 10 μm, etc.); and a difference between the particle size D90 of active material particles of the first active material layer 110 and the particle size D90 of active material particles of the second active material layer 120 is 0.1 μm˜20 μm (e.g., 0.2 μm, 3 μm, 3 μm, 4.6 μm, 5.2 μm, 6.5 μm, 10 μm, 12 μm, 15 μm, 20 μm, etc.).

Exemplarily, in implementations where an active material of the first active material layer 110 is lithium iron phosphate, the lithium iron phosphate meets following conditions.

A particle size D10 is greater than 0.4 μm; for example, the particle size D10 is 0.45 μm, 0.5 μm, 0.8 μm, 0.9 μm, 1 μm, 1.5 μm, 4 μm, 9 μm, etc.

A particle size D50 is 0.8 μm˜4 μm; for example, the particle size D50 is 0.8 μm, 0.9 μm, 1.6 μm, 2.1 μm, 2.8 μm, 3.5 μm, or 4 μm.

A particle size D90 is 3 μm˜10 μm; for example, the particle size D90 is 3 μm, 3.6 μm, 4.1 μm, 4.5 μm, 5.5 μm, 6.8 μm, 7.7 μm, 8.8 μm, 10 μm, etc.

Accordingly, the above conditions can also be adopted if an active material of the second active material layer 120 is the lithium iron phosphate.

Exemplarily, in implementations where an active material of the second active material layer 120 is ternary single crystal material, e.g., the ternary single crystal material is lithium nickel cobalt manganese oxide (Li(NiCoMn)O₂), the ternary single crystal material meets the following conditions.

A particle size D10 is greater than 1.5 μm; for example, the particle size D10 is 1.5 μm, 1.6 μm, 1.8 μm, 2.2 μm, 2.6 μm, 3 μm, 5 μm, or 9.5 μm.

A particle size D50 is 4 μm˜6 μm; for example, the particle size D50 is 4 μm, 4.3 μm, 4.5 μm, 5 μm, 5.6 μm, 5.8 μm, 6 μm, etc.

A particle size D90 is 9 μm˜20 μm; for example, the particle size D90 is 9 μm, 11 μm, 12 μm, 13.6 μm, 14 μm, 16.5 μm, 20 μm, etc.

Exemplarily, in implementations where an active material of the first active material layer 110 is ternary polycrystalline material, e.g., the ternary polycrystalline material is Li(NiCoMn)O₂, and the ternary polycrystalline material meets the following conditions.

A particle size D10 is greater than 1.5 μm; for example, the particle size D10 is 1.5 μm, 1.9 μm, 2.2 μm, 2.5 μm, 3.2 μm, 4.5 μm, 5.5 μm, 10 μm, etc.

A particle size D50 is 8 μm˜12 μm; for example, the particle size D50 is 8 μm, 8.5 μm, 9 μm, 10.6 μm, 11 μm, 12 μm, etc.

A particle size D90 is 18 μm˜34 μm; for example, the particle size D90 is 18 μm, 19 μm, 20 μm, 22 μm, 25 μm, 27 μm, 29 μm, 30 μm, 32 μm, 34 μm, etc.

Exemplarily, an active material of the first active material layer 110 is graphite, and a particle size of the graphite meets the following conditions.

A particle size D10 is greater than 4 μm; for example, the particle size D10 is 4 μm, 4.2 μm, 5 μm, 6.2 μm, 7 μm, etc.

A particle size D50 is 7 μm˜15 μm; for example, the particle size D50 is 7 μm, 8 μm, 8.6 μm, 9.2 μm, 10 μm, 12 μm, 13.5 μm, or 15 μm.

A particle size D90 is no more than 30 μm; for example, the particle size D90 is 30 μm, 32 μm, 37 μm, 40 μm, 42 μm, 45 μm, 48 μm, etc.

Exemplarily, an active material of the first active material layer 110 is silicon carbide, and a particle size of the silicon carbide meets the following conditions.

A particle size D10 is 1 μm˜4 μm; for example, the particle size D10 is 1 μm, 1.5 μm, 2 μm, 2.6 μm, 3 μm, 3.7 μm, 4 μm, etc.

A particle size D50 is 4 μm˜8 μm; for example, the particle size D50 is 4 μm, 6 μm, 7 μm, 7.2 μm, 7.5 μm, 8 μm, etc.

A particle size D90 is 9 μm˜12 μm; for example, the particle size D90 is 9 μm, 10 μm, 11 μm, 11.5 μm, 12 μm, etc.

Exemplarily, an active material of the first active material layer 110 is mesocarbon microbeads, and a particle size of the mesocarbon microbeads meets the following conditions.

A particle size D10 is greater than 4 μm; for example, the particle size D10 is 4 μm, 4.2 μm, 5 μm, 6.2 μm, 7 μm, etc.

A particle size D50 is 7 μm˜15 μm; for example, the particle size D50 is 7 μm, 8 μm, 10 μm, 11 μm, 13 μm, 15 μm, etc.

A particle size D90 is no more than 30 μm; for example, the particle size D90 is 3 μm, 8 μm, 9 μm, 11.5 μm, 18 μm, 25 μm, 30 μm, etc.

Furthermore, in other implementations of the present disclosure, the first active material layer 110 and the second active material layer 120 may have other performance differences in addition to the above differences in particle size distribution. The following is an exemplary description of other performance differences between the first active material layer 110 and the second active material layer 120 in the present disclosure.

In a first example, specific surface areas of active material particles of the first active material layer 110 and the second active material layer 120 are different.

Exemplarily, in the implementations where the electrode sheet 100 is the positive electrode sheet and the first active material layer 110 and the second active material layer 120 have the identical active materials, a difference between a specific surface area of active material particles of the first active material layer 110 and a specific surface area of active material particles of the second active material layer 120 is 0.1 m²/g˜8 m²/g, for example, the difference between specific surface areas is 0.1 m²/g, 0.6 m²/g, 1 m²/g, 1.5 m²/g, 2 m²/g, 2.2 m²/g, 2.3 m²/g, 2.9 m²/g, 3 m²/g, 3.6 m²/g, 4 m²/g, 4.7 m²/g, 5.3 m²/g, 5.8 m²/g, 6.3 m²/g, 7.6 m²/g, or 8 m²/g.

Exemplarily, in the implementations where the electrode sheet 100 is the positive electrode sheet and the first active material layer 110 and the second active material layer 120 have different active materials, a difference between a specific surface area of active material particles of the first active material layer 110 and a specific surface area of active material particles of the second active material layer 120 is 7 m²/g˜15 m²/g, for example, the difference between specific surface areas is 7 m²/g, 8 m²/g, 8.3 m²/g, 8.9 m²/g, 9.4 m²/g, 9.9 m²/g, 10.2 m²/g, 11.1 m²/g, 12.0 m²/g, 13.4 m²/g, 14.3 m²/g, or 15 m²/g.

For example, in the implementations where the active material of the first active material layer 110 is lithium iron phosphate, a specific surface area of the lithium iron phosphate is 8 m²/g˜16 m²/g, for example, the specific surface area of the lithium iron phosphate is 8 m²/g, 10.2 m²/g, 11.3 m²/g, 11.9 m²/g, 12.5 m²/g, 13.6 m²/g, 14.7 m²/g, 15.3 m²/g, or 16 m²/g.

The active material of the second active material layer 120 may also be the lithium iron phosphate with a specific surface area of 8 m²/g˜16 m²/g, as long as a difference between specific surface areas of the two is 1.5 m²/g˜8 m²/g.

For example, the active material of the first active material layer 110 is single crystal Li(NiCoMn)O₂, a specific surface area of the first active material layer 110 is 0.3 m²/g˜0.6 m²/g (e.g., 0.4 m²/g, 0.5 m²/g, or 0.55 m²/g). For example, the active material of the first active material layer 110 is polycrystalline Li(NiCoMn)O₂, a specific surface area of the first active material layer 110 is 0.2 m²/g˜0.6 m²/g (e.g., 0.3 m²/g, 0.4 m²/g, or 0.5 m²/g).

Exemplarily, in the implementations where the electrode sheet 100 is the negative electrode sheet and the first active material layer 110 and the second active material layer 120 have the identical active materials, a difference between a specific surface area of active material particles of the first active material layer 110 and a specific surface area of active material particles of the second active material layer 120 is 0.2 m²/g˜8 m²/g, for example, the difference between specific surface areas is 0.2 m²/g, 0.5 m²/g, 1 m², 1.6 m²/g, 2 m²/g, 2.7 m²/g, 3.6 m²/g, 4 m²/g, 5.7 m²/g, 6 m²/g, 6.3 m²/g, 7.6 m²/g, or 8 m²/g.

Exemplarily, in the implementations where the electrode sheet 100 is the negative electrode sheet and the first active material layer 110 and the second active material layer 120 have different active materials, a difference between a specific surface area of active material particles of the first active material layer 110 and a specific surface area of active material particles of the second active material layer 120 is 0.5 m²/g˜8 m²/g, for example, the difference between specific surface areas is 0.5 m²/g, 1 m²/g, 1.6 m²/g, 2 m²/g, 2.7 m²/g, 3.5 m²/g, 4 m²/g, 5.5 m²/g, 6 m²/g, 6.3 m²/g, 7.5 m²/g, or 8 m²/g.

For example, the active material of the first active material layer 110 is graphite, and a specific surface area of the graphite is 0.5 m²˜8 m²/g (e.g., 0.5 m²/g, 1.6 m²/g, 2 m²/g, 2.8 m²/g, 3.5 m²/g, 4 m²/g, 5.8 m²/g, 6 m²/g, 6.8 m²/g, 7.8 m²/g, or 8 m²/g). For example, the active material of the first active material layer 110 is silicon carbide, a specific surface area of the silicon carbide is 0.5 m²/g˜8 m²/g (e.g., 0.5 m²/g, 1.9 m²/g, 2 m²/g, 2.3 m²/g, 3.3 m²/g, 4 m²/g, 5.3 m²/g, 6 m²/g, 6.3 m²/g, 7.3 m²/g, or 8 m²/g). For example, the active material of the first active material layer 110 is mesocarbon microbeads, and a specific surface area of the mesocarbon microbeads is 0.5 m²/g˜4 m²/g (e.g., 0.5 m²/g, 1.9 m²/g, 2 m²/g, 2.3 m²/g, 3.3 m²/g, or 4 m²/g).

In a second example, a gram capacity of active material particles of the first active material layer 110 is different from a gram capacity of active material particles of the second active material layer.

Exemplarily, in the implementations where the electrode sheet 100 is the positive electrode sheet and the first active material layer 110 and the second active material layer 120 have the identical active materials, a difference between a gram capacity of active material particles of the first active material layer 110 and a gram capacity of active material particles of the second active material layer 120 is 10 mAh/g˜60 mAh/g, e.g., 10 mAh/g, 16 mAh/g, 20 mAh/g, 22 mAh/g, 27 mAh/g, 37 mAh/g, 45 mAh/g, 50 mAh/g, 57 mAh/g, 60 mAh/g, etc.

Exemplarily, in the implementations where the electrode sheet 100 is the positive electrode sheet and the first active material layer 110 and the second active material layer 120 have different active materials, a difference between a gram capacity of active material particles of the first active material layer 110 and a gram capacity of active material particles of the second active material layer 120 is 20 mAh/g˜110 mAh/g, e.g., 20 mAh/g, 32 mAh/g, 47 mAh/g, 60 mAh/g, 72 mAh/g, 86 mAh/g, 97 mAh/g, 100 mAh/g, 110 mAh/g, etc.

For example, in the implementations where the active material of the first active material layer 110 is lithium iron phosphate, a gram capacity of the lithium iron phosphate is 100 mAh/g˜160 mAh/g, e.g., 100 mAh/g, 120 mAh/g, 125 mAh/g, 135 mAh/g, 142 mAh/g, 148 mAh/g, 154 mAh/g, 160 mAh/g, etc.

For example, the active material of the first active material layer 110 is single crystal Li(NiCoMn)O₂, a gram capacity of the first active material layer 110 is 160 mAh/g˜210 mAh/g, e.g., 160 mAh/g, 197 mAh/g, 198 mAh/g, 210 mAh/g, etc.

For example, the active material of the first active material layer 110 is polycrystalline Li(NiCoMn)O₂, which has a gram capacity of 165 mAh/g˜211 mAh/g, e.g., 165 mAh/g, 180 mAh/g, 181 mAh/g, 184 mAh/g, 185 mAh/g, 211 mAh/g, etc. Accordingly, the active material of the second active material layer 120 may also be polycrystalline Li(NiCoMn)O₂, single crystal Li(NiCoMn)O₂, or lithium iron phosphate with the above gram capacities. When the first active material layer 110 and the second active material layer 120 are made of identical materials, a capacity difference between internal active materials of two layers is 10 mAh/g˜60 mAh/g. When the first active material layer 110 and the second active material layer 120 are made of different materials, a capacity difference between internal active materials of the two layers is 20 mAh/g˜110 mAh/g.

Exemplarily, in the implementations where the electrode sheet 100 is the negative electrode sheet and the first active material layer 110 and the second active material layer 120 have the identical active materials, a difference between a gram capacity of active material particles of the first active material layer 110 and a gram capacity of active material particles of the second active material layer 120 is 10 mAh/g˜100 mAh/g, e.g., 10 mAh/g, 29 mAh/g, 41 mAh/g, 53 mAh/g, 67 mAh/g, 83 mAh/g, 97 mAh/g, 100 mAh/g, etc.

Exemplarily, in the implementations where the electrode sheet 100 is the negative electrode sheet and the first active material layer 110 and the second active material layer 120 have different active materials, a difference between a gram capacity of active material particles of the first active material layer 110 and a gram capacity of active material particles of the second active material layer 120 is 10 mAh/g˜200 mAh/g, e.g., 10 mAh/g, 29 mAh/g, 41 mAh/g, 53 mAh/g, 67 mAh/g, 83 mAh/g, 97 mAh/g, 100 mAh/g, 100 mAh/g, 150 mAh/g, 200 mAh/g, etc.

For example, the active material of the first active material layer 110 is graphite, and a gram capacity of the graphite is 250 mAh/g˜360 mAh/g, e.g., 250 mAh/g, 290 mAh/g, 300 mAh/g, 310 mAh/g, 330 mAh/g, or 360 mAh/g. The active material of the first active material layer 110 is silicon carbide, and a gram capacity of the silicon carbide is 360 mAh/g˜1000 mAh/g, e.g., 360 mAh/g, 420 mAh/g, 520 mAh/g, 680 mAh/g, 730 mAh/g, or 1000 mAh/g. The active material of the first active material layer 110 is mesocarbon microbeads, and a gram capacity of the mesocarbon microbeads is 200 mAh/g˜400 mAh/g, e.g., 200 mAh/g, 250 mAh/g, 290 mAh/g, 320 mAh/g, 380 mAh/g, or 400 mAh/g.

In the implementations, after the electrode sheet 100 is prepared into a battery, the first active material layer 110 and an electrode sheet with an opposite polarity to the electrode sheet 100 form a battery with a first electrical performance, and the second active material layer 120 and an electrode sheet with an opposite polarity to the electrode sheet 100 form a battery with a second electrical performance. The battery with the first electrical performance and the battery with the second electrical performance can jointly improve a cycle life of a battery.

In a third example, each of active materials of the first active material layer 110 and the second active material layer 120 is lithium iron phosphate coated with a carbon layer, and a carbon content in the lithium iron phosphate of the first active material layer 110 is different from a carbon content in the lithium iron phosphate of the second active material layer 120. A difference between a carbon coating amount of the lithium iron phosphate in the first active material layer 110 and a carbon coating amount of the lithium iron phosphate in the second active material layer 120 is greater than or equal to 0.1%, and the carbon coating amount (i.e., the carbon content, or the carbon layer content) is a ratio of a mass of the carbon to a total mass of the lithium iron phosphate and the carbon.

In detail, the first active material layer 110 includes the lithium iron phosphate at least partially coated with a carbon layer, and the second active material layer 120 includes the lithium iron phosphate at least partially coated with a carbon layer. A carbon layer content in the first active material layer 110 is different from a carbon layer content in the second active material layer 120. Specifically, the carbon layer content in the first active material layer 110 and the carbon layer content in the second active material layer 120 are 0.8% to 1.6%. In other words, the carbon layer content in the first active material layer 110=the carbon layer content in the second active material layer 120*(1±n), where n is 0.8%˜1.6%, e.g., 0.8%, 0.9%, 1.1%, 1.3%, 1.4%, 1.6%, etc. The carbon layer content is a ratio of a mass of a carbon layer to a total mass of the lithium iron phosphate and the carbon layer.

For example, in the implementations where the active material of the first active material layer 110 is the lithium iron phosphate coated with the carbon layer, a carbon layer content is 0.8%˜1.6%, e.g., 0.8%, 0.9%, 1.1%, 1.3%, 1.5%, 1.6%, etc.

The first active material layer 110 and the second active material layer 120 have different carbon layer contents, such that conductivity and rate capacity of the battery can be improved.

In a fourth example, a compacted density of the active material of the first active material layer 110 is different a compacted density of the active material of the second active material layer 120.

Exemplarily, in the implementations where the electrode sheet 100 is the positive electrode sheet and the first active material layer 110 and the second active material layer 120 have different active materials, a difference between a compacted density of the active material of the first active material layer 110 and a compacted density of the active material of the second active material layer 120 is no less than 0.8 g/cm³, and the difference between compacted densities of the two may be 1.2 g/cm³, 1.5 g/cm³, 2 g/cm³, 2.5 g/cm³, etc.

Exemplarily, in the implementations where the electrode sheet 100 is the positive electrode sheet and the first active material layer 110 and the second active material layer 120 have the identical active materials, a difference between a compacted density of the active material of the first active material layer 110 and a compacted density of the active material of the second active material layer 120 is no less than 0.02 g/cm³, and the difference between compacted densities of the two may be 0.02 g/cm³, 0.3 g/cm³, 0.9 g/cm³, 1.2 g/cm³, 1.5 g/cm³, etc.

For example, in the implementations where the active material of the first active material layer 110 is lithium iron phosphate, a compacted density of the lithium iron phosphate is 2.1 g/cm^{3˜2.6} g/cm³, e.g., 2.1 g/cm³, 2.2 g/cm³, 2.38 g/cm³, 2.4 g/cm³, 2.45 g/cm³, 2.6 g/cm³, etc. Accordingly, the second active material layer 120 may also be made of the lithium iron phosphate with a compacted density of 2.1 g/cm³˜2.6 g/cm³.

For example, the active material of the first active material layer 110 is single crystal Li(NiCoMn)O₂, which has a compacted density of 3.2 g/cm³˜3.75 g/cm³, e.g., 3.2 g/cm³, 3.3 g/cm³, 3.5 g/cm³, 3.75 g/cm³, etc.

For example, the active material of the first active material layer 110 is polycrystalline Li(NiCoMn)O₂, which has a compacted density of 3.2 g/cm³˜3.6 g/cm³, e.g., 3.2 g/cm³, 3.3 g/cm³, 3.5 g/cm³, 3.55 g/cm³, 3.6 g/cm³, etc.

Accordingly, the second active material layer 120 may also be made of the lithium iron phosphate with a compacted density of 2.1 g/cm³˜2.6 g/cm³, polycrystalline Li(NiCoMn)O₂ with a compacted density of 3.2 g/cm³˜3.6 g/cm³, or single crystal Li(NiCoMn)O₂ with a compacted density of 3.2 g/cm³˜3.75 g/cm³.

Exemplarily, the electrode sheet 100 is the negative electrode sheet, a difference between a compacted density of the active material of the first active material layer 110 and a compacted density of the active material of the second active material layer 120 is 0.1 g/cm³˜1.8 g/cm³, and the difference between compacted densities of the two may be 0.1 g/cm³, 0.5 g/cm³, 1.0 g/cm³, 1.5 g/cm³, 1.8 g/cm³, etc.

For example, the active material of the first active material layer 110 is graphite, and a compacted density of the graphite is 1.1 g/cm³˜1.8 g/cm³, e.g., 1.1 g/cm³, 1.3 g/cm³, 1.6 g/cm³, 1.7 g/cm³, 1.8 g/cm³, etc.

For example, the active material of the first active material layer 110 is silicon carbide, and a compacted density of the silicon carbide is 1.1 g/cm³˜2.0 g/cm³, e.g., 1.1 g/cm³, 1.4 g/cm³, 1.6 g/cm³, 1.8 g/cm³, 2.0 g/cm³, etc.

For example, the active material of the first active material layer 110 is mesocarbon microbeads, and a compacted density of the mesocarbon microbeads is 1.1 g/cm³˜2.0 g/cm³, e.g., 1.1 g/cm³, 1.5 g/cm³, 1.7 g/cm³, 1.9 g/cm³, 2.0 g/cm³, etc.

In the implementations, a compacted density difference between the first active material layer 110 and the second active material layer 120 meets the above conditions, such that at a design end, more scheme combinations can be provided to meet energy density requirements of a battery cell, costs of the active material are reduced, and a supply chain is shortened, so as to obtain a greater competitive advantage.

In a fifth example, a thickness of the first active material layer 110 is different from a thickness of the second active material layer 120.

Exemplarily, the electrode sheet 100 is the positive electrode sheet, a difference between the thickness of the first active material layer 110 and the thickness of the second active material layer 120 is 5 μm˜50 μm, for example, the difference between thicknesses of the two layers is 5 μm, 7 μm, 11 μm, 13 μm, 21 μm, 29 μm, 31 μm, 40 μm, 46 μm, 49 μm, 50 μm, etc. Accordingly, for implementations where the thickness of the first active material layer 110 is different from the thickness of the second active material layer 120, the first active material layer 110 and the second active material layer 120 may have identical active materials or different active materials.

For example, the active material of the first active material layer 110 is the lithium iron phosphate, and a coating amount of the first active material layer 110 is 5 mg/cm²˜22 mg/cm², e.g., 5 mg/cm², 6 mg/cm², 7 mg/cm², 9 mg/cm², 10 mg/cm², 11 mg/cm², 13 mg/cm², 14 mg/cm², 16 mg/cm², 18 mg/cm², 20 mg/cm², 21 mg/cm², or 22 mg/cm².

For example, the active material of the first active material layer 110 is single crystal Li(NiCoMn)O₂, and the coating amount of the first active material layer 110 is 10 mg/cm²˜26 mg/cm², e.g., 10 mg/cm², 13 mg/cm², 14 mg/cm², 15 mg/cm², 16 mg/cm², 17 mg/cm², 19 mg/cm², 20 mg/cm², 22 mg/cm², 24 mg/cm², or 26 mg/cm².

For example, the active material of the first active material layer 110 is polycrystalline Li(NiCoMn)O₂, and the coating amount of the first active material layer 110 is 10 mg/cm²˜26 mg/cm², e.g., 10 mg/cm², 14 mg/cm², 15 mg/cm², 17 mg/cm², 19 mg/cm², 20 mg/cm², 22 mg/cm², 23 mg/cm², 25 mg/cm², or 26 mg/cm².

Accordingly, a coating amount of the second active material layer 120 may also refer to coating amounts of the above three materials.

Exemplarily, the electrode sheet 100 is the negative electrode sheet, a difference between the thickness of the first active material layer 110 and the thickness of the second active material layer 120 is 5 μm˜100 μm, for example, the difference between thicknesses of the two layers is 5 μm, 7 μm, 11 μm, 13 μm, 21 μm, 29 μm, 31 μm, 40 μm, 46 μm, 49 μm, 50 μm, 70 μm, 85 μm, 90 μm, 100 μm, etc. Accordingly, for the implementations where the thickness of the first active material layer 110 is different from the thickness of the second active material layer 120, the first active material layer 110 and the second active material layer 120 may have the identical active materials or different active materials.

For example, the active material of the first active material layer 110 is graphite, a coating amount of the first active material layer 110 is 5 mg/cm² 15 mg/cm², e.g., 5 mg/cm², 8 mg/cm², 10 mg/cm², 13 mg/cm², 14 mg/cm², or 15 mg/cm².

For example, the active material of the first active material layer 110 is silicon carbide, the coating amount of the first active material layer 110 is 5-10 mg/cm², e.g., 5 mg/cm², 7 mg/cm², 9 mg/cm², 10 mg/cm², 12 mg/cm², 14 mg/cm², or 15 mg/cm².

For example, the active material of the first active material layer 110 is mesocarbon microbeads, the coating amount of the first active material layer 110 is 5-10 mg/cm², e.g., 5 mg/cm², 7 mg/cm², 9 mg/cm², or 10 mg/cm².

Accordingly, reference of a coating amount of the second active material layer 120 can also be made to coating amounts of the above three materials.

In some implementations of the present disclosure, the first active material layer 110 can be set to be different from the second active material layer 120 according to at least one of the first example, the second example, the third example, the fourth example, and the fifth example described above. Alternatively, in some implementations, the first active material layer 110 may be different from and the second active material layer 120 only in particle sizes.

In implementations illustrated in FIG. 1, the current collector 101 is a metal foil. In the implementations where the electrode sheet 100 is the positive electrode sheet, the current collector 101 is an aluminum foil. In the implementations where the electrode sheet 100 is the negative electrode sheet, the current collector 101 is a copper foil.

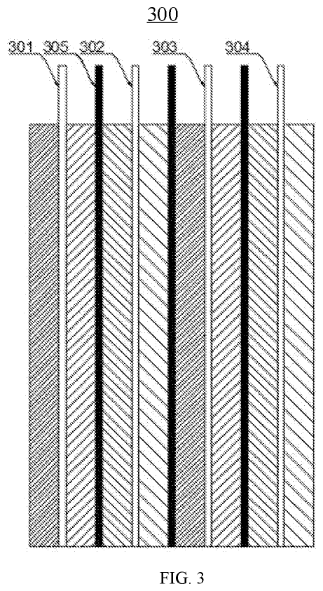

FIG. 2 is a schematic cross-sectional structural diagram of an electrode sheet 200 provided in another implementation of the present disclosure. Reference can be made to FIG. 2.

In FIG. 2, a current collector 201 includes a support layer 203 and metal layers 202, and the metal layers 202 covers two surfaces of the support layer 203.

The metal layers 202 are provided with the first active material layer 110 and the second active material layer 120 on two surfaces of the metal layers 202 away from the support layer 203 respectively.

Exemplarily, the support layer 203 can be made of one or more of polyester, polyolefin, polyamide, polyimide, polyether, epoxy resin, phenol-formaldehyde resin, any crosslink thereof, or any copolymer thereof.

The metal layer 202 may be made of aluminum or copper.

For the first active material layer 110 and the second active material layer 120 in the electrode sheet 200 illustrated in FIG. 2, reference can be made to the description of the electrode sheet 100 in FIG. 1 above, which will not be repeated here.

The electrode sheet 200 provided in the implementations of the present disclosure at least has following advantages.

The above difference exists between the particle size distribution of the first active material layer 110 and the particle size distribution of the second active material layer 120. After the electrode sheet 200 and electrode sheets each with an opposite polarity to the electrode sheet 200 are prepared into a battery, the first active material layer 110, a separator, and an electrode sheet with an opposite polarity to the electrode sheet 200 constitute one battery, and the second active material layer 120, and a separator, and an electrode sheet with an opposite polarity to the electrode sheet 200 constitute another battery. A battery includes at least two kinds of batteries with different electrical performances, and the two batteries have different performances, such that performances of the two batteries complement each other to form the battery with a better electrical performance.

An electrode sheet assembly is further provided in the present disclosure. The electrode sheet assembly includes a separator, and two kinds of electrode sheets with opposite polarities located at two sides of the separator. At least one kind of the two kinds of electrode sheets is the above electrode sheet 100. For example, the two kinds of electrode sheets are the above electrode sheets 100 with opposite polarities respectively.

In the implementations, the electrode sheet assembly includes two kinds of electrode sheets, which are a positive electrode sheet and a negative electrode sheet. The number of positive electrode sheet is greater than or equal to 1, and the number of negative electrode sheet is greater than or equal to 1. For implementations where the number of positive electrode sheets is greater than 1, each positive electrode sheet may be identical, or only some of positive electrode sheets are identical; and structures of some or all of positive electrode sheets are described as structures of the above electrode sheet 100. Accordingly, for implementations where the number of negative electrode sheets is greater than 1, each negative electrode sheet may be identical, or only some of the number of negative electrode sheets are identical; and structures of some or all of negative electrode sheets are described as structures of the above electrode sheet 100.

Reference can be made to FIG. 3, which is a schematic cross-sectional structural diagram of an electrode sheet assembly provided in implementations of the present disclosure. In the implementations, an electrode sheet assembly 300 includes a first electrode sheet 301, a second electrode sheet 302, a third electrode sheet 303, and a fourth electrode sheet 304, and a separator 305. The first electrode sheet 301 and the second electrode sheet 302 each are positive electrode sheets, and the second electrode sheet 302 and the fourth electrode sheet 304 each are negative electrode sheets. The above difference exists between particle size distributions of two surfaces of the first electrode sheet 301. Two adjacent electrode sheets are separated by a separator 305. The above difference exists between particle size distributions of two surfaces of the second electrode sheet 302. The above difference exists between particle size distributions of active material layers of two surfaces of the third electrode sheet 303. The above difference exists between particle size distributions of active material layers of two surfaces of the fourth electrode sheet 304.

In some implementations of the present disclosure, the first electrode sheet 301 may be identical with or different from the third electrode sheet 303, and the second electrode sheet 302 may be identical with or different from the fourth electrode sheet 304.

Tabs of the electrode sheet assembly 300 illustrated in FIG. 3 are at an identical side. It can be understood that in other implementations, tabs of the electrode sheet assembly 300 can be located at different sides.

As described above, since the above difference exists between particle size distributions of two surfaces of an electrode sheet, after an electrode sheet assembly 300 is wound or laminated to form a battery, at least two batteries with different electrical performances will be formed, such that multiple batteries with different electrical performances will complement each other to improve an electrical performance of a final battery.

In some implementations of the present disclosure, any one of a positive current collector and a negative current collector of the electrode sheet assembly 300 is a composite current collector, and another is a metal foil current collector. In other words, the positive current collector is the composite current collector, and the negative current collector is the metal foil current collector; or the negative current collector is the composite current collector, and the positive current collector is the metal foil current collector.

For example, the first electrode sheet 301 and the third electrode sheet 303 each include composite current collectors, and the second electrode sheet 302 and the fourth electrode sheet 304 each include metal foil current collectors; or the first electrode sheet 301 and the third electrode sheet 303 each include metal foil current collectors, and the second electrode sheet 302 and the fourth electrode sheet 304 each include composite current collectors. Two adjacent electrode sheets are separated by the separator 305.

Batteries are individually provided by implementation 1, implementation 2, and comparative example 1, and a battery includes a positive electrode sheet, a separator, and a negative electrode sheet. The positive electrode sheet includes an aluminum foil, a conductive layer and a first active layer which are located on one surface of the aluminum foil, and a conductive layer and a second active layer which are located on another surface of the aluminum foil.

The negative electrode sheet includes a copper foil, a conductive layer and a third active layer which are located on one surface of the copper foil, and a conductive layer and a fourth active layer which are located on another surface of the copper foil.

The first active layer is made of a first active slurry by coating, and the first active slurry includes an active material, conductive carbon black, and an adhesive agent with a mass fraction of 96: 2: 2.

The second active layer is made of a second active slurry by coating, and the second active slurry includes an active material, conductive carbon black, and an adhesive agent with a mass fraction of 96: 2: 2.

Table 1 illustrates main parameters of the first active layer and the second active layer of the positive electrode sheet. Table 2 illustrates main parameters of two active layers (which are named as the third active layer and the fourth active layer) of the negative electrode sheet. In table 1 and table 2, a specific surface area, a gram capacity, a particle size, a carbon layer content, a thickness, and a compacted density all indicate performances of active material particles.

TABLE 1

| | | | | | | | Carbon | | |
|---|---|---|---|---|---|---|---|---|---|
| | Positive | | Thickness of | Specific | Gram | Particle size | layer | Coating | Compacted |
| | electrode | | conductive | surfaces | capacity | distribution | content | amount | density |
| | sheet | Material | layer/um | area m²/g | mAh/g | (μm) | wt % | mg/cm² | (g/cm³) |
| Comparative | First | Lithium iron | 2 | 12 | 146 | D10 is 0.6 | 0.80% | 20 | 2.35 |
| example 1 | active | phosphate | | | | D50 is 2.8 | | | |
| | layer | | | | | D90 is 9.6 | | | |
| | Second | Lithium iron | 2 | 12 | 146 | D10 is 0.6 | 0.80% | 20 | 2.35 |
| | active | phosphate | | | | D50 is 2.8 | | | |
| | layer | | | | | D90 is 9.6 | | | |
| Implementation | First | Lithium iron | 2 | 12 | 146 | D10 is 0.6 | 0.80% | 20 | 2.35 |
| 1 | active | phosphate | | | | D50 is 2.8 | | | |
| | layer | | | | | D90 is 9.6 | | | |
| | Second | Lithium iron | 2 | 15.6 | 158 | D10 is 0.4 | 1.50% | 20 | 2.35 |
| | active | phosphate | | | | D50 is 1.5 | | | |
| | layer | | | | | D90 is 4.3 | | | |
| Implementation | First | Lithium iron | 2 | 12 | 146 | D10 is 0.6 | 0.80% | 20 | 2.35 |
| 2 | active | phosphate | | | | D50 is 2.8 | | | |
| | layer | | | | | D90 is 9.6 | | | |
| | Second | Polycrystalline | 2.3 | 0.4 | 208 | D10 is 3.8 | NA | 24.3 | 3.45 |
| | active | nickel cobalt | | | | D50 is 10.3 | | | |
| | layer | manganese | | | | D90 is 31.2 | | | |
| | | (811) | | | | | | | |

TABLE 2

| | Negative | | Thickness of | Specific | Gram | Particle size |
|---|---|---|---|---|---|---|
| | electrode | | conductive | surfaces | capacify | distribution |
| | sheet | Material | layer/um | area m²/g | mAh/g | (μm) |
| Comparative | Fourth | Graphite | 1 | 1.3 | 340 | D10 is 5.2 |
| example 1 | active | | | | | D50 is 16.6 |
| | layer | | | | | D90 is 45 |
| | Third | Graphite | 1 | 1.3 | 340 | D10 is 5.2 |
| | active | | | | | D50 is 16.6 |
| | layer | | | | | D90 is 45 |
| Implementation | Fourth | Graphite | 1 | 1.3 | 340 | D10 is 5.2 |
| 1 | active | | | | | D50 is 16.6 |
| | layer | | | | | D90 is 45 |
| | Third | Mesocarbon | 1.1 | 2.4 | 350 | D10 is 7 |
| | active | microbeads | | | | D50 is 12 |
| | layer | | | | | D90 is 18.4 |
| Implementation | Fourth | Graphite | 1 | 1.3 | 340 | D10 is 5.2 |
| 2 | active | | | | | D50 is 16.6 |
| | layer | | | | | D90 is 45 |
| | Third | Silicon | 1.1 | 2.5 | 680 | D10 is 9 |
| | active | carbide | | | | D50 is 18 |
| | layer | | | | | D90 is 34 |

Cycle lives, rates, internal resistances, energy densities, high and low temperature characteristics of the batteries provided by implementation 1, implementation 2, and comparative example 1 are detected. Test results are illustrated in table 3.

TABLE 3

| | | | | | 50% state of |
|---|---|---|---|---|---|
| | Gravimetric | Cycle number | | Range of | charge (SOC) direct |
| | energy | at 75% | Rate at | designed operating | current resistance |
| | density | capacity | 25° C. | temperature | (DCR)/mΩ |
| Comparative | 176.4 wh/kg | 6500 | 3 C@90% | −20~60° C. | 0.436 |
| example 1 | | | | | |
| Experimental | 182.8 wh/kg | 10000 | 3 C@95% | −30~60° C. | 0.412 |
| example 1 | | | | | |
| Experimental | 195.8 wh/kg | 4800 | 3 C@92% | −30~60° C. | 0.408 |
| example 2 | | | | | |

In table 3, 3C@90% represents: at 25° C., 3C discharge is adopted, and a discharge capacity is 90% of a rated capacity. Correspondingly, 3C@95% represents: at 25° C., 3C discharge is adopted, and the discharge capacity is 95% of the rated capacity. 3C@92% represents: at 25° C., 3C discharge is adopted, and the discharge capacity is 92% of the rated capacity.

50% SOC DCR/mΩ represents: when a temperature is at 25° C. and SOC is 50%, 3C discharge is adopted for 30 seconds, and discharge DCR is obtained by calculating.

The following can be seen from table 3.

Compared with comparative example 1, in implementation 1, a designed coating weight and a designed compacted density are not changed, a positive electrode material of a second layer has a small particle size, a large specific surface area, a short electron migration path, and improved carbon coating. A negative electrode material of a third layer is made of mesocarbon microbeads. For this material, a gram capacity is improved, isotropy is great, a rate capacity is improved, a cycle life is greatly improved, and a lowest temperature of a range of low-temperature operating is reduced to −30° C. A material of the second active layer has a small particle size, a great dynamic performance, relatively small electrochemical impedance and concentration impedance, and unchanged thickness and ohmic impedance of a conductive layer, therefore, overall DCR is reduced. For the negative electrode, a particle size distribution of the mesocarbon microbeads is relatively narrow and small, the thickness of the conductive layer is increased, and DCR is also relatively small.

Compared with comparative example 1, a material of the second active layer of the positive electrode in implementation 2 is changed to polycrystalline nickel cobalt manganese (811 system), a gram capacity of polycrystalline nickel cobalt manganese is much higher than a gram capacity of lithium iron phosphate, and a unit weight of polycrystalline nickel cobalt manganese is also much heavier than a unit weight of lithium iron phosphate, such that a designed coating weight and a designed compacted density each are relatively large, and a gravimetric energy density is finally increased greatly. Due to a relatively large particle size and a relatively small specific surface area, a cycle number is greatly reduced. Polycrystalline nickel cobalt manganese has a great conductivity and needs no carbon coating, such that an overall performance is improved. Polycrystalline nickel cobalt manganese has a relatively great performance at low temperatures, such that a lowest temperature of a range of designed operating temperature of a battery cell can be reduced to −25° C. in a low temperature region. Compared with comparative example 1, a third layer of the negative electrode is made of silicon carbide, which has a relatively high gram capacity, a reduced coating weight, and a reduced thickness of an electrode, such that an energy density is also improved. Due to relatively large volume expansion and fragile particles during a cycle process, a cycle performance is slightly degraded. The second active layer is polycrystalline nickel cobalt manganese, which has a great conductivity to reduce an ohmic impedance, while increasing a thickness of the second conductive layer to improve its overcurrent capacity, such that an overall ohmic impedance is greatly reduced. A combination of an electrochemical impedance and a concentration impedance of polycrystalline nickel cobalt manganese is not larger than a combination of an electrochemical impedance and a concentration impedance of lithium iron phosphate, such that overall DCR is greatly reduced. A conductivity of a negative silicon carbide material is slightly reduced (which will lead to growth of DCR), but the thickness of the conductive layer increases, such that a comprehensive effect is that the negative electrode has a slightly increased influence on DCR, but the positive electrode has a great influence on DCR, therefore, overall DCR is reduced.

In summary, it can be seen that the electrode sheet 100 provided by the embodiment of the present disclosure has better electrical performance.

The above description is only a preferred embodiment of the present disclosure, and is not used to limit the present disclosure. For those of ordinary skill in the art, the present disclosure may have various changes and changes. Any modification, equivalent replacement, improvement, etc. made within the spirit and principles of this disclosure shall be included in the scope of protection of this disclosure.

What is claimed is:

1. An electrode sheet, comprising:
a current collector having a first surface and a second surface opposite to the first surface;
a first active material layer covering at least a part of the first surface; and
a second active material layer covering at least a part of the second surface.

2. The electrode sheet of claim 1, wherein the electrode sheet is a positive electrode sheet, the first active material layer and the second active material layer have identical active materials, a difference between a particle size D10 of active material particles of the first active material layer and a particle size D10 of active material particles of the second active material layer is 0.05 μm˜0.3 μm; a difference between a particle size D50 of the active material particles of the first active material layer and a particle size D50 of the active material particles of the second active material layer is 1 μm˜4 μm; and a difference between a particle size D90 of the active material particles of the first active material layer and a particle size D90 of the active material particles of the second active material layer is 3 μm˜5 μm; or
the electrode sheet is the positive electrode sheet, the first active material layer and the second active material layer have different active materials, a difference between a particle size D10 of active material particles of the first active material layer and a particle size D10 of active material particles of the second active material layer is 1 μm˜3 μm; a difference between a particle size D50 of the active material particles of the first active material layer and a particle size D50 of the active material particles of the second active material layer is 2 μm˜5 μm; and a difference between a particle size D90 of the active material particles of the first active material layer and a particle size D90 of the active material particles of the second active material layer is 3 μm˜25 μm.

3. The electrode sheet of claim 1, wherein the electrode sheet is a negative electrode sheet, the first active material layer and the second active material layer have identical active materials, a difference between a particle size D10 of active material particles of the first active material layer and a particle size D10 of active material particles of the second active material layer is 0.1 μm˜4 μm; a difference between a particle size D50 of the active material particles of the first active material layer and a particle size D50 of the active material particles of the second active material layer is 0.1 μm˜8 μm; and a difference between a particle size D90 of the active material particles of the first active material layer and a particle size D90 of the active material particles of the second active material layer is 0.1 μm˜10 μm; or
the electrode sheet is the negative electrode sheet, the first active material layer and the second active material layer have different active materials, a difference between a particle size D10 of active material particles of the first active material layer and a particle size D10 of active material particles of the second active material layer is 0.1 μm˜4 μm; a difference between a particle size D50 of the active material particles of the first active material layer and a particle size D50 of the active material particles of the second active material layer is 0.1 μm˜10 μm; and a difference between a particle size D90 of the active material particles of the first active material layer and a particle size D90 of the active material particles of the second active material layer is 0.1 μm˜20 μm.

4. The electrode sheet of claim 2, wherein when the first active material layer and the second active material layer have the identical active materials, and a difference between a compacted density of the active material particles of the first active material layer and a compacted density of the active material particles of the second active material layer is no less than 0.02 g/cm³; or
the electrode sheet is the positive electrode sheet, the first active material layer and the second active material layer have the different active materials, and a difference between a compacted density of the active material particles of the first active material layer and a compacted density of the active material particles of the second active material layer is no less than 0.8 g/cm³.

5. The electrode sheet of claim 3, wherein a difference between a compacted density of the active material particles of the first active material layer and a compacted density of the active material particles of the second active material layer is 0.1 g/cm³˜1.8 g/cm³.

6. The electrode sheet of claim 2, wherein the active material of the first active material layer and/or the second active material layer is lithium iron phosphate, and the lithium iron phosphate satisfies following conditions:
a particle size D10 is greater than 0.4 μm;
a particle size D50 is 0.8 μm˜4 μm; and
a particle size D90 is 3 μm˜10 μm.

7. The electrode sheet of claim 2, wherein the active material of the first active material layer and/or the second active material layer is ternary single crystal material, and the ternary single crystal material satisfies following conditions:
the particle size D10 is greater than 1.5 μm;
the particle size D50 is 4 μm˜10 μm; and
the particle size D90 is 9 μm˜20 μm.

8. The electrode sheet of claim 2, wherein the active material of the first active material layer and/or the second active material layer is ternary polycrystalline material, and the ternary polycrystalline material satisfies following conditions:
the particle size D10 is greater than 1.5 μm;
the particle size D50 is 8 μm˜12 μm; and
the particle size D90 is 18 μm˜34 μm.

9. The electrode sheet of claim 3, wherein the active material of the first active material layer and/or the second active material layer is graphite, and the graphite satisfies following conditions:
the particle size D10 is greater than 4 μm;
the particle size D50 is 7 μm˜15 μm; and
the particle size D90 is no more than 30 μm.

10. The electrode sheet of claim 3, wherein the active material of the first active material layer and/or the second active material layer is silicon carbide, and the silicon carbide satisfies following conditions:
the particle size D10 is 1 μm˜4 μm;
the particle size D50 is 4 μm˜8 μm; and
the particle size D90 is 9 μm˜12 μm.

11. The electrode sheet of claim 3, wherein the active material of the first active material layer and/or the second active material layer is mesocarbon microbeads, and the mesocarbon microbeads satisfy following conditions:
the particle size D10 is greater than 4 μm;
the particle size D50 is 7˜15 μm; and
the particle size D90 is no more than 30 μm.

12. The electrode sheet of claim 1, wherein the first active material layer and the second active material layer each comprise lithium iron phosphate, a difference between a carbon coating amount of the lithium iron phosphate in the first active material layer and a carbon coating amount of the lithium iron phosphate in the second active material layer is greater than or equal to 0.1%, and the carbon coating amount is a ratio of a mass of the carbon to a total mass of the lithium iron phosphate and the carbon.

13. The electrode sheet of claim 2, wherein when the first active material layer and the second active material layer have the identical active materials, a difference between a specific surface area of the active material particles of the first active material layer and a specific surface area of the active material particles of the second active material layer is 0.1 m²/g˜8 m²/g; or
when the first active material layer and the second active material layer have the different active materials, a difference between a specific surface area of the active material particles of the first active material layer and a specific surface area of the active material particles of the second active material layer is 7 m²/g˜15 m²/g.

14. The electrode sheet of claim 3, wherein when the first active material layer and the second active material layer have the identical active materials, a difference between a specific surface area of the active material particles of the first active material layer and a specific surface area of the active material particles of the second active material layer is 0.2 m²/g˜8 m²/g; or
when the first active material layer and the second active material layer have the different active materials, a difference between a specific surface area of the active material particles of the first active material layer and a specific surface area of the active material particles of the second active material layer is 0.5 m²/g˜8 m²/g.

15. The electrode sheet of claim 2, wherein when the first active material layer and the second active material layer have the identical active materials, a difference between a gram capacity of the active material particles of the first active material layer and a gram capacity of the active material particles of the second active material layer is 10 mAh/g˜60 mAh/g; or
when the first active material layer and the second active material layer have the different active materials, a difference between a gram capacity of the active material particles of the first active material layer and a gram capacity of the active material particles of the second active material layer is 20 mAh/g˜110 mAh/g.

16. The electrode sheet of claim 3, wherein when the first active material layer and the second active material layer have the identical active materials, a difference between a gram capacity of the active material particles of the first active material layer and a gram capacity of the active material particles of the second active material layer is 10 mAh/g˜100 mAh/g; or
when the first active material layer and the second active material layer have the different active materials, a difference between a gram capacity of the active material particles of the first active material layer and a gram capacity of the active material particles of the second active material layer is 10 mAh/g˜200 mAh/g.

17. The electrode sheet of claim 2, wherein a difference between a thickness of the first active material layer and a thickness of the second active material layer is 5 μm˜50 μm.

18. The electrode sheet of claim 3, wherein a difference between a thickness of the first active material layer and a thickness of the second active material layer is 5 μm˜100 μm.

19. An electrode sheet assembly, comprising a separator, and two electrode sheets which are located at two sides of the separator and have opposite polarities; wherein
at least one of the two electrode sheets comprises:
a current collector having a first surface and a second surface opposite to the first surface;
a first active material layer covering at least a part of the first surface; and
a second active material layer covering at least a part of the second surface.

20. The electrode sheet assembly of claim 19, wherein one of a positive current collector and a negative current collector of the electrode sheet assembly is a composite current collector, and another is a metal foil current collector.
